(19) United States
(12) Patent Application Publication
(10) Pub. No.: US 2009/0152183 A1
(43) Pub. Date: Jun. 18, 2009

(54) Disinfection System Improvements

(75) Inventors: Murray K. Stewart, Kingswood (AU); John D. Aitken, Alexandria (AU)

Correspondence Address: EDWARDS ANGELL PALMER & DODGE LLP, P.O. BOX 55874, BOSTON, MA, 02205, US

(73) Assignee: Packaged Environmental Solutions Pty Ltd., Eveleigh , NSW (AU)

(21) Appl. No.: 12/084,499

(22) PCT Filed: Oct. 30, 2006
(86) PCT No.: PCT/AU2006/001623

§ 371 Date: Nov. 13, 2008

(30) Foreign Application Priority Data
Nov. 2, 2005 (AU) 2005906072

(51) Int. Cl. C02F 1/16; G05D 23/00

(52) U.S. Cl. 210/181; 165/279

(57) ABSTRACT

Apparatus for disinfecting fluid. The apparatus includes a disinfection tank including a heat exchanger extending from an inlet to an outlet for heating preheated fluid to a second temperature to thereby disinfect the fluid. A preheat heat exchanger is provided for heating the fluid to a first temperature using heat recovered from disinfected fluid provided at the outlet and a control system, including one or more sensors for monitoring operation of the apparatus, is used for determining if signals from the sensors fall outside predetermined operating ranges and either generating an indication of a fault or stopping operation of the apparatus.

### BACKGROUND OF THE INVENTION

The present invention relates to a method and apparatus for disinfecting fluids, and in particular, to apparatus for disinfecting fluids using heat treatment, as well as to apparatus for providing a combination supply, and in particular for supplying a combination of hot water, air conditioning and disinfected water.

### DESCRIPTION OF THE PRIOR ART

The reference to any prior art in this specification is not, and should not be taken as, an acknowledgement or any form of suggestion that the prior art forms part of the common general knowledge.

It is well known to provide for disinfection of fluids to destroy or inactivate organisms, viruses and pathogens in the fluids, by heating fluids to a predetermined temperature for a predetermined amount of time. Typically when it is desired to disinfect large or small volumes of fluid this is achieved either by heating the fluid in a holding tank or metallic tank

However, current systems for disinfecting fluid tend to be expensive and energy inefficient, as well as having a short lifecycle due to corrosion of the holding tank, making the supply of large volumes of disinfected fluid an expensive process.

Whilst alternatives have been suggested, these techniques are also typically inefficient. For example, in ensuring sufficient sanitation of sewer water, it is typical to use reverse osmosis which uses membranes that are very costly to operate and run while not fully reusing all of the waste water with significant losses in the treatment process.

Furthermore, when providing facilities in remote areas, such as hot water, disinfected water, air conditioning, and the like, efficiency of operation of systems becomes important, primarily in minimising both operating and environmental costs.

A similar issue is encountered with ships ballast water. Ballast water is used to maintain buoyancy and stability for a ship carrying varying amounts of cargo. In order to achieve this, as the ship is loaded or unloaded it is typical to remove or add ballast water to or from the local harbour. When the ship reaches its destination port, and is unloaded, it is again typical to add or remove ballast water from the ballast tanks. In this instance, this allows the destination port to be contaminated with water from the port of origin which thereby provides a mechanism for marine organisms, pathogens and other contaminants to travel from one port to another.

In order to reduce such risks, ships are required to cycle their ballast water at sea by emptying each of the ballast tanks in turn and replenishing the empty tanks with seawater. This is a complex and time consuming process and incurs significant risks to the safety of the vessel. In particular, when a ballast tank is empty this places undue strain on the hold and can lead to hull breaches. In addition to this, whilst the water is being replenished the ship generally suffers from poor stability and can therefore capsize in heavy seas.

As a result of this, ship's captains often are unable to cycle the ballast water as required, often leading to contamination of different harbours.

### SUMMARY OF THE PRESENT INVENTION

In a first broad form the present invention provides apparatus for disinfecting fluid, the apparatus including:
a) a disinfection tank including a heat exchanger extending from an inlet to an outlet for heating preheated fluid to a second temperature to thereby disinfect the fluid;
b) a preheat heat exchanger for heating the fluid to a first temperature using heat recovered from disinfected fluid provided at the outlet; and,
c) a control system including one or more sensors for monitoring operation of the apparatus, the control system being for:
   i) determining if signals from the sensors fall outside predetermined operating ranges; and,
   ii) at least one of:
      (1) generating an indication of a fault; and,
      (2) stopping operation of the apparatus.

Typically the control system is for monitoring at least one of:
a) an operating temperature;
b) water levels;
c) pump operation;
d) heat element operation; and,
e) power supply operation.

Typically the heat exchanger has a predetermined length.

Typically the heat exchanger is formed from a convoluted pipe.

Typically the heat exchanger is formed from a coiled pipe.

Typically the coiled pipe is adapted to reduce the effects of channelling within the pipe.

Typically the heat source includes a primary circuit and at least one of:
a) a heating element; and,
b) a second heat exchanger coupled to a source of hot fluid.

Typically the hot fluid is heated by at least one:
a) waste heat from equipment; and,
b) solar heating.

Typically the disinfection tank is a reverse acting califorier.

Typically the disinfection tank is a Rotex™ SC500.

Typically the heat exchanger is a PE-X heat exchanger.

Typically the preheat heat exchanger is a second reverse acting califorier.

Typically the preheat heat exchanger is a second Rotex™ SC500.

Typically the second inlet and second outlet are coupled to a primary circuit of the second Rotex™ SC500.

Typically the preheat heat exchanger is a PE-X heat exchanger.

Typically the disinfection tank includes an insulated housing.

Typically the heat source includes pipe coupled to a boiler.

Typically the fluid at the second temperature is pressurised.

Typically the apparatus includes one or more pressure release valves.

Typically the fluid is provided at a predetermined rate, and wherein the heat exchanger is adapted to heat the fluid to the second temperature for a predetermined length of time.

Typically the apparatus further includes a control system for controlling the predetermined rate.

Typically the control system includes:
a) a flow control valve; and,
b) a controller for controlling the flow control valve.

Typically the apparatus further includes a temperature sensor which generates signals indicative of the second temperature, and wherein the controller controls the predetermined flow rate in accordance with the signals.

Typically the controller is a suitably programmed processing system.

In a second broad form the present invention provides apparatus for disinfecting fluid, the apparatus including:
a) a disinfection tank including a heat exchanger extending from an inlet to an outlet for heating preheated fluid to a second temperature using waste heat from a generator, to thereby disinfect the fluid;
b) a preheat heat exchanger for heating the fluid to a first temperature using heat recovered from disinfected fluid provided at the outlet;
c) a pump for pumping fluid through the disinfection tank and the preheat heat exchanger; and,
d) a control system including a temperature sensor coupled to the generator, the control system being adapted to control an operating speed of the pump using signals from the temperature sensor.

Typically the transfer of waste heat from the generator is used to cool the generator, and wherein the control system is for:
a) increasing the pump speed in response to an increase in the temperature of the generator; and,
b) decreasing the pump speed in response to a decrease in the temperature of the generator.

In a third broad form the present invention provides apparatus for disinfecting fluid, the apparatus including:
a) a disinfection tank including a heat exchanger extending from an inlet to an outlet for heating preheated fluid to a second temperature to thereby disinfect the fluid;
b) a preheat heat exchanger for heating the fluid to a first temperature using heat recovered from disinfected fluid provided at the outlet; and,
c) a treatment system for pre-treating fluid supplied to the preheat heat exchanger.

Typically the treatment system includes at least one of:
a) a filter system for filtering the fluid to remove particulate material;
b) a reverse osmosis system for removing salt from the fluid;
c) a vacuum distillation system for removing salt from the fluid; and,
d) a sewage treatment plant for pre-treating sewage.

In a fourth broad form the present invention provides a supply system including:
a) a generator for generating electricity;
b) an absorption chiller for using exhaust gases from the generator to provide chilled fluid;
c) a fluid disinfection system including a disinfection tank having a heat exchanger extending from an inlet to an outlet for using waste heat from the generator to disinfect fluid; and,
d) a hot water system for using waste heat from the generator to provide heated fluid.

Typically the hot water system is formed from a second heat exchanger provided in the fluid disinfection system.

Typically the apparatus further includes a storage tank for storing disinfected water for use as potable water.

Typically the hot water system is coupled to the storage tank to heat disinfected fluid.

Typically the apparatus further includes:
a) one or more washing units coupled to the storage tank and the hot water supply for providing washing facilities; and
b) one or more toilets.

Typically the apparatus further includes:
a) a sewage treatment system for treating waste water from at least one of the toilets and the washing units to produce treated waste water; and,
b) a second fluid disinfection system coupled to the sewage treatment system for disinfecting the treated waste water, the disinfected treated waste water being used by the one or more toilets.

Typically the apparatus further includes a filtration system for filtering the treated waste water prior to disinfection.

Typically the apparatus is provided as a modular system including a number of containers.

Typically the containers are shipping containers.

Typically:
a) a first container contains the generator;
b) a second container contains the absorption chiller; and,
c) a third container contains the fluid disinfection system and the hot water system.

Typically the apparatus includes a fourth container containing one or more washing units and one or more toilets.

In a fifth broad form the present invention provides apparatus for disinfecting fluid, the apparatus including:
a) a preheat heat exchanger for heating the fluid to a first temperature, the preheat heat exchanger including:
   i) a first inlet for receiving the fluid;
   ii) a first outlet for supplying preheated fluid at the first temperature; iii) a second inlet for receiving disinfected fluid substantially at a second temperature; and,
   iv) a second outlet for supplying the disinfected fluid; and,
b) a disinfection tank for heating the fluid to a second temperature, the disinfection tank including:
   i) a heat source;
   ii) an inlet for receiving the preheated fluid;
   iii) a heat exchanger coupled to the inlet for heating the preheated fluid to a second temperature to thereby disinfect the fluid; and,
   iv) an outlet coupled to the heat exchanger for providing the disinfected fluid to the second inlet of the preheat heat exchanger.

Typically the heat exchanger is formed from a coiled or convoluted pipe adapted to reduce the effects of channelling within the pipe.

In a sixth broad form the present invention provides method of operating apparatus for disinfecting fluid, the apparatus including:
a) a preheat heat exchanger for heating the fluid to a first temperature, the preheat heat exchanger including:
   i) a first inlet for receiving the fluid;
   ii) a first outlet for supplying preheated fluid at the first temperature;
   iii) a second inlet for receiving disinfected fluid substantially at a second temperature; and,
   iv) a second outlet for supplying the disinfected fluid; and,
b) a disinfection tank for heating the fluid to a second temperature, the disinfection tank including:
   i) a heat source;
   ii) an inlet for receiving the preheated fluid;
   iii) a heat exchanger coupled to the inlet for heating the preheated fluid to a second temperature to thereby disinfect the fluid; and,
   iv) an outlet coupled to the heat exchanger for providing the disinfected fluid to the second inlet of the preheat heat exchanger; and,
   v) wherein the method includes supplying the fluid to the first inlet at a predetermined rate.

In a seventh broad form the present invention provides a supply system including:
a) an absorption chiller for using an external heat source to provide chilled fluid;
b) a fluid disinfection system including a disinfection tank having a heat exchanger extending from an inlet to an outlet for using an external heat source to provide disinfected fluid;
c) a hot water system for using an external heat source to provide heated fluid; and,
d) a waste heat recovery system to recover waste heat, the waste heat recovery system acting as an external heat source for at least one of the absorption chiller, the fluid disinfection system and the hot water storage system.

Typically the waste heat recovery system includes a heat exchanger coupled to at least one of:
a) a generator; and,
b) a boiler.

Typically the waste heat recovery system provides heat to a selected one of the absorption chiller, the fluid disinfection system and the hot water system, the system further including a second waste heat recovery system for:
a) recovering waste heat from the selected one of the absorption chiller, the fluid disinfection system and the hot water system; and
b) providing the waste heat to one of the absorption chiller, the fluid disinfection system and the hot water system.

Typically the fluid disinfection system includes:
a) a preheat heat exchanger for heating the fluid to a first temperature, the preheat heat exchanger including:
   i) a first inlet for receiving the fluid;
   ii) a first outlet for supplying preheated fluid at the first temperature;
   iii) a second inlet for receiving disinfected fluid substantially at a second temperature; and,
   iv) a second outlet for supplying the disinfected fluid; and,
b) a disinfection tank coupled to an external heat source for heating the fluid to a first temperature, the disinfection tank including:
   i) an inlet for receiving the preheated fluid;
   ii) a heat exchanger coupled to the inlet for heating the preheated fluid to a second temperature to thereby disinfect the fluid; and,
   iii) an outlet coupled to the heat exchanger for providing the disinfected fluid to the second inlet of the preheat heat exchanger.

In a seventh broad form the present invention provides supply system including:
a) a fluid disinfection system including a disinfection tank having a heat exchanger extending from an inlet to an outlet for using an external heat source to provide disinfected fluid;
b) a hot water system for using an external heat source to provide heated fluid; and,
c) a waste heat recovery system to recover waste heat, the waste heat recovery system acting as an external heat source for at the fluid disinfection system and the hot water storage system.

In a eighth broad form the present invention provides apparatus for treating ballast water in a vessel, the apparatus including:
a) a preheat heat exchanger for heating the ballast water to a first temperature, the preheat heat exchanger including:
   i) a first inlet for receiving the ballast water from a ballast tank;
   ii) a first outlet for supplying preheated ballast water at the first temperature;
   iii) a second inlet for receiving disinfected ballast water substantially at a second temperature; and,
   iv) a second outlet for supplying the disinfected ballast water to the ballast tank; and,
b) a disinfection tank for heating the ballast water to the second temperature, the disinfection tank including:
   i) an inlet for receiving the preheated ballast water;
   ii) a heat exchanger coupled to the inlet for heating the preheated ballast water to a second temperature to thereby disinfect the ballast water; and,
   iii) an outlet coupled to the heat exchanger for providing the disinfected ballast water to the second inlet of the preheat heat exchanger; and,
c) a heat recovery heat system coupled to engines provided in the vessel, the heat recovery system being adapted to heat the disinfection tank, thereby allowing the ballast water to be disinfected.

Typically the first inlet is coupled to the ballast tank at a first level and the second outlet is coupled to the ballast tank at a second level, the second level being higher than the first level to thereby ensure disinfected water is returned to the ballast tank at a higher level.

In a ninth broad form the present invention provides apparatus for treating ballast water in a vessel, the apparatus including:
a) a heat recovery heat system for recovering heat from at least one of an engine and a boiler; and,
b) a fluid disinfection system for heating the ballast water to a predetermined temperature using the recovered waste heat, to thereby disinfect the ballast water.

### BRIEF DESCRIPTION OF THE DRAWINGS

An example of the present invention will now be described with reference to the accompanying drawings, in which:—

FIG. 1 is a schematic overview of apparatus for disinfecting fluid;

FIG. 2A is a schematic diagram of a first specific example of apparatus for disinfecting fluid;

FIG. 2B is a schematic diagram of a second specific example of apparatus for disinfecting fluid;

FIG. 3 is a schematic diagram of an example of a fluid disinfection system and filtration system;

FIG. 4 is a schematic diagram of an example of a variable speed fluid disinfection system;

FIG. 5 is a schematic diagram of an example of a controller for the fluid disinfection system of FIG. 4;

FIG. 6 is a schematic diagram of an example of an absorption chiller;

FIG. 7 is a schematic diagram of an example of a hot water storage system;

FIG. 8 is a schematic diagram of a first example of a combination system including a fluid disinfection system, an absorption chiller and a hot water storage system;

FIGS. 9A and 9B are schematic diagrams of an example of a modular combination system;

FIG. 10 is a schematic diagram of an example of a self-contained combination supply system; and,

FIG. 11 is a schematic diagram of an example of the use of a fluid disinfection system for disinfecting ballast water.

### DETAILED DESCRIPTION OF THE PREFERRED EMBODIMENTS

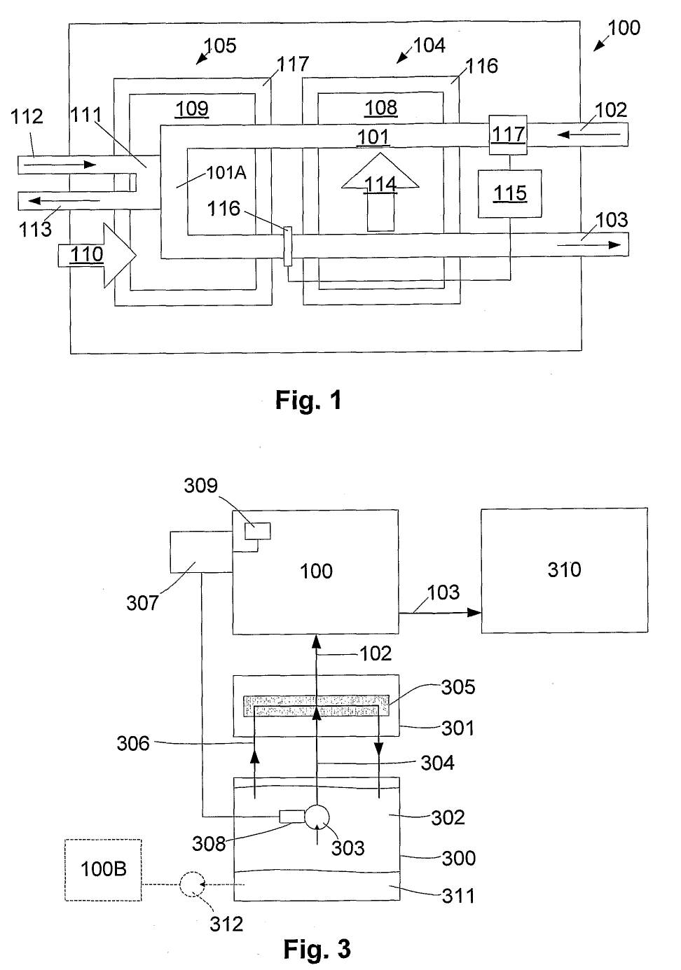

An example of fluid disinfection system will now be described with reference to FIG. 1.

In this example, the fluid disinfection system 100 includes a pipe 101, having an inlet 102 and an outlet 103. The pipe 101 passes through a first heat exchanger 104 and a second heat exchanger 105.

In general, the heat exchangers 104, 105 include respective insulated housings 106, 107 each defining a cavity 108, 109 as shown. The cavity 109 includes a pipe 111 having an inlet 112, and an outlet 113, which is provided adjacent a portion 101A of the pipe 101. In this example, an external heat source 110 is provided to heat water in the cavity 109 to thereby heat the fluid in the pipe 101. In one example this can be achieved by heating another fluid in the pipe 111 additionally, or alternatively other external or internal heat sources 110 may be used to supply heat to the cavity 109, such as electric heating elements or the like. Heating in the first heat exchanger 104 is provided by fluid exiting the second heat exchanger 105, as shown at 114.

Each cavity 108, 109 may be filled with a substance such as water, for retaining heat to thereby improve the efficiency of the heat exchanger as will be appreciated by a person skilled in the art.

In use, fluid to be disinfected is received at the inlet 102 and is transferred along the pipe 101 into the first heat exchanger 104 which provides initial heating of the fluid to a first temperature. The second heat exchanger 105 then heats the fluid to a second temperature. The pipe 101 is arranged so that when the fluid is transferred through the pipe 101 at a predetermined rate, the fluid will spend a predetermined amount of time at the second temperature to thereby ensure the fluid is disinfected.

Fluid exiting the second heat exchanger 105 at the second temperature heats the incoming fluid to the first temperature in the first heat exchanger 104, with the disinfected fluid being provided via the outlet 103.

Using waste heat from the fluid exiting the second heat exchanger 105 to pre-heat the fluid received at the inlet 102, reduces the amount of heating required in the second heat exchanger 105, by the heat source 110. This allows for a wide range of heat sources to be used, such as waste heat from boilers, generators, air conditioning, or the like as well renewable energy such as solar heating or the like. In the event that insufficient heat is available, any one or more sources can and/or used in conjunction with an internal heating element, or the like.

As will be appreciated by persons skilled in the art, the length of time required to disinfect the fluid will depend on the second temperature used, and the nature of the fluid and contaminants to be deactivated. In general, a higher second temperature will result in the disinfection process taking less time, which in turn allows a higher flow rate of fluid through the pipe 101, for a given pipe length.

To further enhance the volume of fluid which can be disinfected the portion of the pipe within the second heat exchanger 105, shown generally at 101A, is at least partially convoluted to thereby increase the length of the portion 101A within the cavity 109.

In order to ensure that the fluid is correctly disinfected it is necessary to control the flow rate in accordance with both the length of the pipe 101, and the nature of the fluid. This may be achieved by providing one or more flow control valves 117, such as proportional flow valves coupled to an appropriate controller 115, to thereby ensure the fluid is maintained at the second temperature for a sufficient time period. This may be achieved in accordance with signals received, by the controller 115, from a temperature sensor 116.

The controller 115 may be any form of controller that is adapted to respond to signals from the temperature sensor 116, and thereby control the relative opening of the flow valve 117, to thereby maintain a desired flow rate. In one example, this can be achieved using a suitable thermostat and relay. Alternatively however this may therefore be achieved using a suitably programmed processing system, such as a computer, laptop, palm top, PDA, specialised hardware, programmable logic controller, or the like. This is performed in order to ensure that the fluid receives the required degree of heating to fully disinfect the fluid and destroy any contaminants or the like therein.

Alternatively, the system can be configured to use a predetermined flow rate, which can be defined for example by a fixed orifice. In this case, for example, the inlet 102 may have a fixed cross-sectional area, such that fluid flowing into the pipe 101 flows at a predetermined controlled rate. In this case, it will be appreciated that no form of additional dynamic flow control, such as the provision of the controller 115 is required.

Typically, in the case of the fluid being water, it is necessary for the second temperature to be above 50° C. and preferably above 80° C. In a preferred example, water is heated to a temperature of between 85° C. and 90° C. in the second heat exchanger 105. In this case, the first heat exchanger 104 will typically preheat the water to within a few degrees of the second temperature, and accordingly the first temperature will be in the region of 80 to 85° C.

It will be appreciated however that the temperature used will depend on the application for which the system is used. Thus, for example, if the system is used to treat ballast water, a lower temperature, such as 50° C. may be used, whereas treating fluid for quarantine purposes may require up to 121° C. This will depend factors such as the contaminants to be treated, the intended use of the fluid, any restrictions on time available of disinfection and the degree of external heating available.

In any event, in order to ensure that the fluid is correctly disinfected, to thereby destroy any contaminants, it is necessary to ensure that the fluid is held at the second temperature for a predetermined amount of time, which is based on the flow rate and the length of the pipe portion 101A. Thus, in the example set out above, the pipe 101 is convoluted to increase the length of the portion 101A, to thereby increase the length of time that the fluid remains at the second temperature for at predetermined flow rate.

However, when determining the amount of time the fluid spends in the pipe portion 101A, it is important to take into account the effects of channelling within the pipe 101. In particular, when fluid flows through a pipe, the fluid forms a boundary layer on the inner surface of the pipe. This boundary layer tends to be subject to greater frictional forces than fluid towards the centre of the pipe, and will therefore flow at a slower rate.

As a result, when determining the flow rate and the pipe length it is necessary to ensure that all the fluid remains at the second temperature for the predetermined amount of time. This can be accounted for in two main ways.

Firstly, the theoretical predetermined time for performing disinfection at the operating temperature is determined. The flow rate is then controlled to provide a safety margin, to thereby ensure that the fluid takes longer than the predetermined time to travel through the pipe portion 101A.

Secondly, the pipe portion 101A is designed so as to reduce the effects of channelling. In one example, this is achieved by arranging for the pipe portion 101A to be coiled. The use of a coiled arrangement tends to introduce turbulence and vortices into the flow within the pipe 101, which in turn disrupts the boundary layer, and therefore reduces the effects of channelling. As a result, there fluid flowing through the pipe portion 101A tends to flow at a more uniform rate, thereby ensuring that all the fluid spends an equal amount of time within the pipe portion 101A at the second temperature.

In order to reduce the amount of heating required in the second heat exchanger 105, it will be appreciated by persons skilled in the art, that it is preferable to minimise the difference between the first and second temperatures. Accordingly, it is typical that the first temperature is within a few degrees of the second temperature, and preferable that the first temperature is within one or two degrees of the second temperature.

However, in some circumstances the heat source 110 will provide a fixed degree of heating which heats the fluid in the second heat exchanger by more than a few degrees. This may occur for example if the heat source 110 is formed from waste heat from equipment, and it is required to remove a predetermined amount of heat from the equipment to prevent overheating. In this case, it may be desirable to increase the temperature difference between the first and second temperatures, to thereby ensure that the waste heat is removed.

It will be appreciated by persons skilled in the art that the relative values of the first and second temperatures will depend to a large extent on the configuration of the first heat exchanger 104, and this will therefore be selected depending on the heat source 110.

In the above example, and though the following examples, water or other fluid flow through the pipes or other flow paths is achieved using appropriate pumps which are not shown for clarity purposes, as will be appreciated by persons skilled in the art.

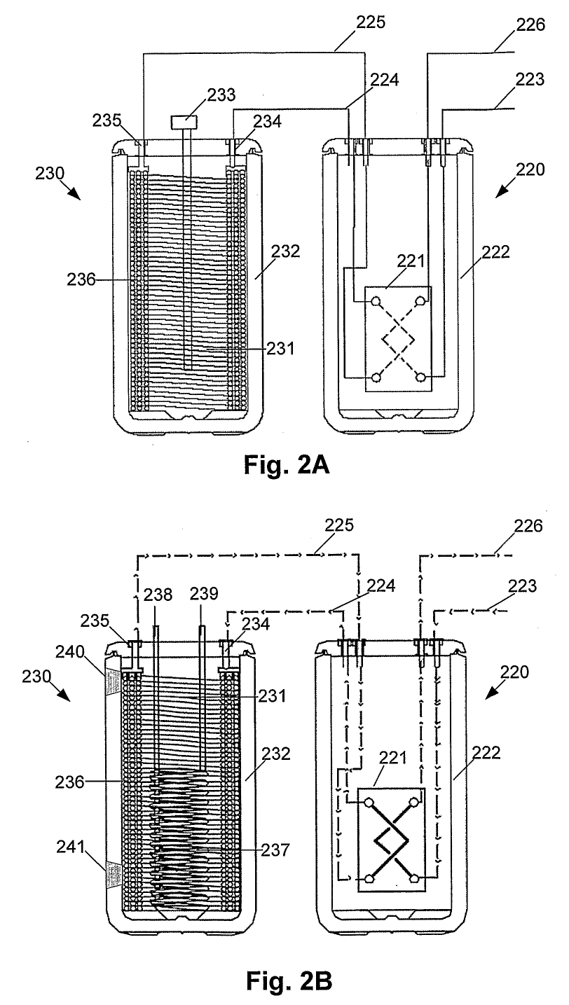

Examples of specific apparatus configurations for performing this will now be described with reference to FIGS. 2A and 2B.

In particular, FIG. 2A shows a first configuration including a preheat tank 220, formed from a heat exchanger 221 provided in an insulated housing 222. The preheat tank 220 includes an inlet pipe 223 for receiving the fluid to be disinfected and an outlet pipe 224, for providing fluid at the first temperature. A second inlet pipe 225 is provided for receiving the disinfected fluid at the second temperature, with a second outlet pipe 226 being used to provide the disinfected fluid.

The outlet pipe 224, and the second inlet pipe 225, are connected to a disinfection tank 230 formed from a reverse acting calorifier. This may be formed from any suitable apparatus and generally includes an insulated housing for retaining heat, and a heat exchanger. In one example this is formed from a Rotex™ SC500 heat exchanger, although other apparatus may be used.

The Rotex SC500 heat exchanger or equivalent, which is also referred to as a “Rotex Sanicube”, includes a cavity 231 provided in an insulated housing 232. The fluid in the cavity 231 is heated by a heat source 233, to thereby store heat energy. The heat source 233 can be an electric element providing between 2.4 to 24 kilowatts of heating. In this example, a six kilowatt Incalloy 800 element or equivalent, is used to provide the necessary degree of heating.

The disinfection tank 230 includes an inlet 234, and an outlet 235, coupled to a heat exchanger 236, which in this example is a PE-X type heat exchanger, but may an equivalent heat exchanger. In this example inlet and outlet 234, 235 are coupled to the outlet pipe 224, and the second inlet pipe 225, of the preheat tank 220, respectively.

In use, fluid is supplied to the preheat tank 220, and is preheated to the first temperature, which is typically within a few degrees of the second temperature, by the fluid exiting the disinfection tank 230. The preheated fluid is supplied to the inlet 234, and passes through the PE-X heat exchanger 236, where it is heated by the water in the cavity 231, to the second temperature, which is at least 60° C., and more preferably at least 85° C.

In this particular configuration and given the limitations of the dimensions and length of the PE-X Heat Exchanger 236, this allows up to 2000 litres of fluid per hour to be disinfected in a typical modular package form. At this rate, fluid typically spends around 4 minutes at the second temperature, which represents more than enough time to disinfect the fluid. In practice at temperatures of between 85° C. and 90° C., disinfection would typically take about 1 minute, and accordingly, even providing a 50% safety margin to ensure disinfection of all fluid, this would allow higher flow rates than 2000 litres per hour to be used in practice.

A second example configuration is shown in FIG. 2B. In this example the electric heat element 233 is replaced by a heat exchanger 237. In particular, the heat exchanger 237 includes an inlet 238 and an outlet 239 to provide fluid heated by an external source, such as solar heating or the like. The heated fluid in the heat exchanger 237 operates to heat the fluid in the cavity 231. Apart from this the operation is substantially as described above.

It will be appreciated by persons skilled in the art that this allows waste heat from sources such as air conditioning or the like, or renewable sources such as solar heating, to be used as a suitable heat source for disinfection. This allows disinfection to be achieved using renewable energy sources, or the like.

This configuration of operation is extremely efficient. In particular, whilst the Rotex SC500 is extremely efficient, it would still require a relatively large amount of energy to heat the disinfecting fluid directly to a suitable second temperature without pre heating. However by preheating the fluid to be disinfected using the fluid leaving the Rotex SC500, this makes the system far more energy efficient thereby vastly improving efficiency.

As a further development, the preheat tank 200 can also be formed from a Rotex SC500, with water flowing through the heat exchanger 236 prior to entering the disinfection tank 230, and then flowing through the heat exchanger 237 after exiting the disinfection tank. Thus, in this instance, the heat exchanger and the primary water circuit within a Rotex SC500 replace the plate heat exchanger 221, shown in FIGS. 2A and 2B. Otherwise operation is substantially as above and will not therefore be described in any further detail.

It will be appreciated that in the event that insufficient heating can be provided via the heat exchanger 237, for example if the temperature of the fluid received at the inlet 238 is too low, then additional heating may be provided using a heating element, such as the heating element 233 described in FIG. 2A above.

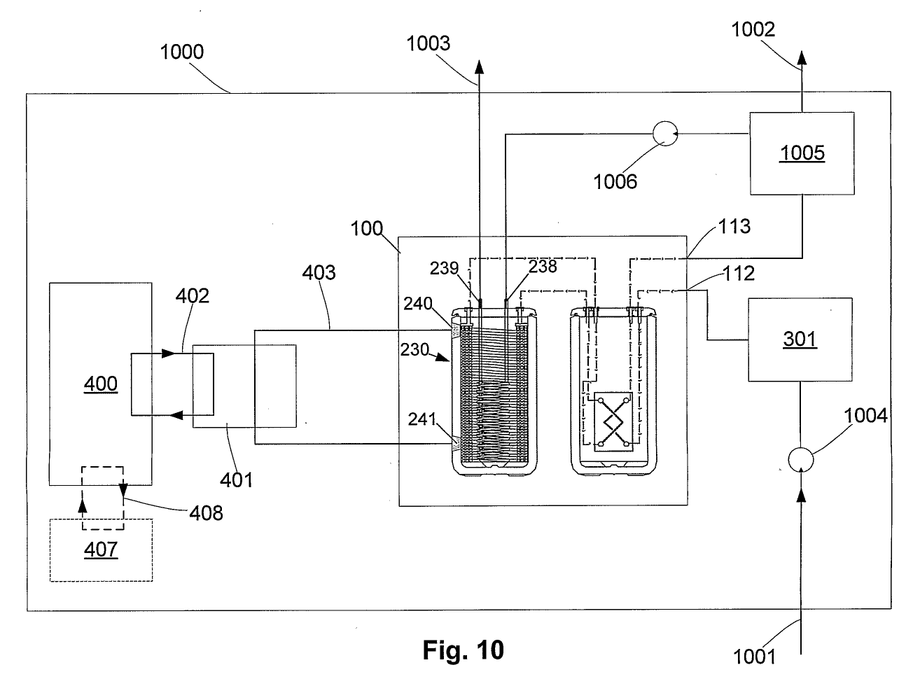

A further variation is to use side connectors 240, 241 to recirculate the water within the cavity. In this instance, this can be used to connect the disinfection tank 230 to a remote heat source. This allows additional heat sources to be used, but also allows the heat exchanger 237 to be used as a hot water supply. In this instance, all heating effecting is provided either via an electric element or the like, and by recirculating water to a heat source using the side connectors 240, 241. Water to be heated can then be supplied to the inlet 238, allowing a supply of hot water to be provided at the outlet 239. This allows the system to be used to provide both heated and disinfected water. This will be described in more detail below with respect to FIG. 10.

An example of the use of a fluid disinfection system (FDS) 100, together with an associated filter to allow treatment of fluids provided in a holding tank, which may form part of a preliminary treatment system, will now be described with reference to FIG. 3.

In this example, a holding tank 300 is coupled to a filtration system 301 via a connecting pipe 304. The holding tank 300 contains fluid 302, which can be pumped through the connecting pipe 304 using a pump 303. The filtration system includes a filter 305 that is also coupled to the holding tank 300 via a backwash circuit 306. The connecting pipe 304 passes through the filter 305 and connects to the FDS inlet 102. A controller 307 is also provided coupled to the FDS 100 and the pump 303.

In use, fluid is pumped through the connecting pipe 304 using the pump 303 and then passes through the filter 305 providing filtered water to the FDS 100, via the inlet 102. The FDS 100 then operates to disinfect the fluid providing the disinfected fluid at the outlet 103, in a manner similar to that described above. The disinfected water can be stored in a separate treated water tank 310 as shown. In the event that the fluid disinfected water is to be held in the treated water tank for a period of time, it is sometimes desirable to provide additional treatment using a low dose chlorine treatment process to provide residual treatment. This provides residual disinfection to prevent post disinfection contamination.

The filter 305 is designed to remove particulate matter and other solids to prevent such matter entering the fluid disinfection system. The size of the filter used will vary depending on the preferred application but in one example is a one-micron filter.

As will be appreciated by persons skilled in the art, in use the filter 305 will tend to become blocked with particulate material over time and accordingly the filter is periodically cleaned by flushing water through the filter using the backwash circuit 306. This operation will be understood by a person skilled in the art.

To ensure correct operation the control unit 307 is coupled to a pump sensor 308, provided on the pump 303, to monitor pump operation. In the event that the pump fails for example due to power failure or a blockage in the connecting pipe 304, this is detected by the controller 307.

The controller 307 can also be coupled one or more sensors shown generally at 309. The sensors can include, for example:
a thermometer;
a power sensor;
a heat element sensor; and,
a water level sensor.

This allows the control unit 307 to monitor the sensors and generate an alert in the event that signals from the sensor fall outside a predetermined range indicative of normal operating parameters for the FDS 100. This can be used for example to detect a power or heat element failure, as well as to detect if the water level or temperature fall outside preferred operating ranges.

This allows the FDS 100 to diagnose any faults. This can then be used to trigger warning indications, such as through the use of visual or audible indicators, and additionally, or alternatively, automatically shutting down the FDS 100 if required, thereby preventing damage to the equipment should a fault occur.

One example of the use of this configuration is providing disinfection of sewage for use as non-potable water. In this example, the holding tank 300 forms part of a sewage treatment plant (STP), such as a Kelair Blivet™ STP, acting as a primary/secondary STP. The filter is in the form of a hydra-sub submersible micro-filtration system or similar.

The outcome of the entire system is the complete treatment of raw sewage to safe non potable water that can be re-used for irrigation, toilets, fire fighting etc and is achieved without the excessive usage of chemicals or power.

It will be appreciated that other arrangements may also be used depending on the preferred implementation.

One issue with these arrangements is the potential for sludge creation. In this instance, as the sewage is aerated, a sludge forms on the bottom of the tank, as shown generally at 311. To avoid undue contamination of the water being treated, the pump 303 is generally arranged to extract fluid from the tank at a level above the sludge 311.

Previously in such systems the sludge was periodically removed and either transported this to another location for disposal, or by incinerated. However, the sludge contains pathogens and is therefore typically unsuitable for dumping in an untreated form. Furthermore, incinerating the sludge, whilst this will destroy the pathogens, generally leaves a residual sludge containing high concentrations of heavy metals, which is consequently extremely toxic and therefore unsuitable in disposal in the environment.

To avoid this, the system can be adapted to extract sludge from the tank 300 using a second pump 312. The sludge is then disinfected using an FDS 100B as shown in dotted lines. In this instance, by using an FDS to treat the sludge, this makes the sludge suitable for disposal, without concentrating the toxic heavy metal elements.

In general a separate FDS 100B is used to disinfect the sludge to thereby avoid contamination of the water being treated for reuse. However, as an alternative, the system can use a single FDS 100, with the sludge and water disinfection being performed with independent circuits. Thus for example, the sludge can be disinfected within the heat exchanger 237, whilst the water is disinfected within the primary water circuit 231. This avoids the need for additional equipment, whilst ensuring that the water and sludge are treated independently.

In the above example, the holding tank 300 may form part of one or more different types of pre-treatment process, depending on the fluid being disinfected.

For example in the event in which the fluid contains chemical contamination, pre-treatment of the fluid is required to remove this contamination. In particular, the fluid disinfection system 100 in only able to kill pathogens and bacteria and would not therefore remove chemical contaminants. In this instance it is typical to use a treatment system such as an ozone or electro-coagulation system to the remove the chemical contaminants before the fluid is subsequently treated by the FDS 100.

In the event in which the fluid treated contains salt, such as if salt water is being treated, it is typical to provide a reverse osmosis system to remove the salt. This will still leave biological contaminants that can then be removed by the fluid disinfection system. As an alternative to this a vacuum distillation process can be used to remove the salt, which is particular useful in high mineral salt contamination situations as high mineral salt concentrations typically are more aggressive than standard salt-water contamination.

Trials of the configuration shown in FIG. 3 were performed by the National Marine Science Centre at the Woolgoolga Sewage Treatment Plant, which is operated by the Coffs Harbour City Council, in New South Wales. In use, the FDS 100 was positioned after secondary treatment (activated sludge) STP 300 and filtering (disc filters) 305 and results were compared to standard disinfection by chlorine.

In this example, the STP 300 used a preliminary stage of treatment consisting of 3 mm step screens and grit removal. The works uses the Sequence Batch Reactor (SBR) system, which replaces conventional primary and secondary treatment processes. This is an aerated activated sludge process with two tanks of approximately 4 mL capacity. The influent is fed alternately to each tank, so that whilst one tank is filling the other is processing. Aluminium sulphate and magnesium hydroxide are added before the SBR. The cycle involves four stages, filling, aeration, settling and decanting. Denitrification takes place in the initial anoxic “selector” zone, and the sludge age is 40 days. The number of surface aerators deployed varied to maintain the dissolved oxygen level at the required level (which may be 0.6 to 2.0 mg/L).

Water from the SBR passes to a holding tank 300 in the form of a catchpond (6.1 mL capacity) before being filtered with Liquitek disc filters 305.

In the prior art configuration, the fluid is disinfected with chlorine through hypochlorite and 30 minutes retention. The effluent is then used for the irrigation, mainly of bananas. During times of low demand the effluent is discharged into the sea through the new Deep Sea Release at Coffs Harbour.

To test the operation of the FDS 100, the FDS 100 was positioned after the catchpond and disc filters. Water was drawn through a 25 mm pipe, using a small pump, from the collection tank following the disc filers and delivered to the FDS unit. Temporary alternative inlet and outlets fitted with a gate valve were used to draw off samples for analysis. Both faecal coliforms and total coliforms were measured, before and after disinfection. Results were also obtained following the standard disinfection by chlorine for comparison.

The samples were tested for faecal coliform and total coliforms, by the CHCC Environmental Analysis Laboratory, which is National Association Of Testing Authorities (NATA) accredited. The membrane filter technique (MFT) was used in the analysis, and in particular method APHA 9222D for the faecal coliforms and APHA 9222B for total coliforms (Standard Methods 1998).

Table 1 shows a summary of the results. Of the 48 results obtained for the faecal coliforms over the eight-week period, the median count was <1 with a mean of 9.1 cfu/100 mL, and for the total coliforms with 24 results over a 5-week period the median was <1 and the mean 6.73 cfu/100 mL. In contrast the chlorinated effluent had median and mean values of <1 and 0.7 cfu/100 mL for faecal coliforms and 1.0 and 3.00 cfu/100 mL for total coliforms.

However, it was apparent that some of the variability was due to incorrect set-up of the device with the inlet pipe 102 being coupled to the upstream side of the filter 305, so that effectively unfiltered water was being treated. For the final two weeks of the test the FDS exceeded the performance of the normal chlorination. The reduction over this period was almost 100% for both faecal and total coliforms, and it could be postulated that this period was when the unit had fully “recovered” from the initial problem of taking unfiltered water.

TABLE 1

| | |
|---|---|
| Faecal | Total |
| Coliforms | Coliforms |
| (cfu/100 mL) | (cfu/100 mL) |

| | FDS | Chlorine | FDS | Chlorine |
|---|---|---|---|---|
| Mean | 9.1 | 0.7 | 6.73 | 3.00 |
| Median | <1 | <1 | <1 | 1 |
| Mode | <1 | <1 | <1 | <1 |
| Standard Dev | 22.90 | 1.90 | 11.25 | 4.68 |
| Maximum | 116 | 9 | 34 | 14 |
| Minimum | <1 | <1 | <1 | <1 |
| Range | 116 | 9 | 34 | 14 |
| Standard Error | 3.31 | 0.40 | 2.05 | 1.21 |

Further details are discussed in a paper “Chemical Free Disinfection Using The Fluid Disinfection System (FDS)™” by Professor Richard Faulkner—University of New England, NSW and National Marine Science Centre, Coffs Harbour.

The fluid disinfection system described system is suitable for disinfecting a wide range of fluids in high volume. In particular, the system is ideally suited for disinfecting both grey fluid, which includes fluid from showers, wash basins, dishwashers and washing machines, and black fluid, which includes fluid from toilets, septic systems etc, and which typically contains amounts of contaminants, such as Faecal coliforms and bacteria, as well target species of organisms, bacteria, pathogens and compounds, such as oestrogen, nitrates, phosphates, and the like.

It will be appreciated that residual purification, such as filtering or chlorination for residual treatment, may also be provided depending on the attended use of the treated water.

Due to the improved quality of disinfected fluid compared to other fluid cleaning techniques it is possible to utilise the system in a greater variety of circumstances. Thus, for example, the systems can be used to treat effluent from sewage plants and septic tanks, as well as waste water from industry, making it safe for re-use or disposal. In addition to this, animal effluent can be disinfected for use in irrigation of crops or pasture. Polluted river or dam water can be disinfected allowing it to be used as potable water. The system can also be used to disinfect ballast water on boats/ships, allowing the ballast water to be safely returned to the sea or rivers.

In any event, it will be appreciated that this allows water from a variety of sources to be collected and then distributed for a variety of uses, such toilet water, irrigation, cleaning, or the like.

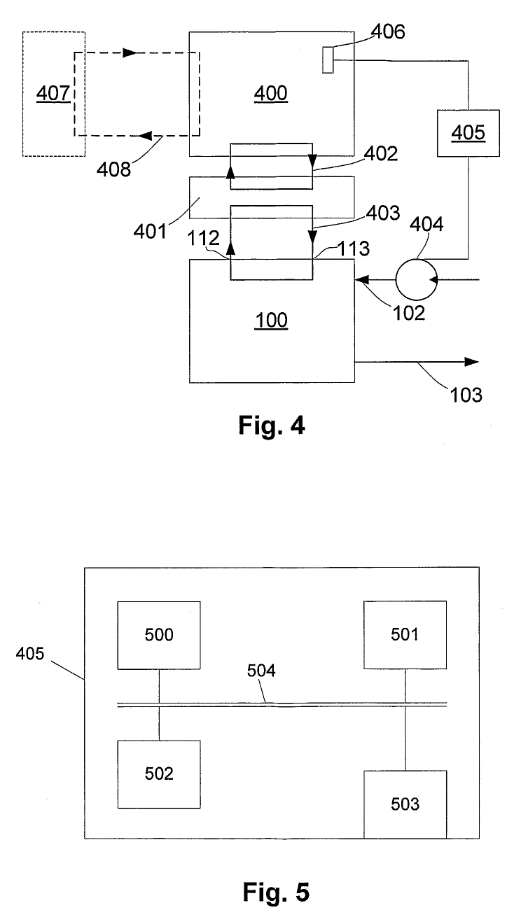

An example of a system utilising a fluid disinfection system 100 to disinfect varying fluid volumes and to provide for variable cooling of a generator will now be described with reference to FIG. 4.

In this example a generator 400 is coupled to a heat exchanger 401 via a heat exchanger fluid circuit 402. The heat exchanger 401 is then coupled to the FDS 100 via the outlets 112 and inlets 113 as shown by the fluid circuit 403. A pump 404 is coupled to the FDS inlet 102 to provide fluid for disinfection from a suitable source. The pump 404 is a variable speed pump, which is controlled utilising a controller 405, which is in turn coupled to a temperature sensor 406. The generator 400 may optionally be coupled to a radiator 407 via a radiator circuit 408, as shown.

In use, the operating temperature of the generator 400 will vary depending on its current utilisation. Thus, if the generator 400 is producing a high volume of electricity it will typically have to run at a higher speed and consequently at a higher temperature. As a result of this there is an additional cooling requirement. In normal circumstances, such cooling is handled solely by the radiator 407. However, in the current arrangement, the controller 405 is adapted to detect the increasing temperature utilising the temperature sensor 406. In this instance, the controller can increase the speed of the pump 404, thereby increasing the rate of fluid flow through the FDS 100.

In this example, the increase of temperature of the generator 400 leads to a consequent increase in heat transfer to the FDS 100 via the heat exchanger 401 thereby raising the temperature of the FDS 100. As the time taken to disinfect fluid depends on the disinfection temperature, the increased temperature allows a greater volume of fluid to be disinfected by increasing the rate of fluid flow through the FDS 100. Furthermore, by increasing the fluid flow rate though the FDS 100, this operates to increase the heat sink effect provided by the FDS 100, thereby providing additional cooling to the generator 400.

Consequently this arrangement allows the generator 400 to be cooled solely using the FDS 100, with variations in the operating temperature of the generator 400 being accommodated by adjusting the fluid flow rate through the FDS 100.

This allows the radiator 407 to be wholly removed as indicated by the dotted lines. However, in some circumstances it is preferable to provide the radiator to allow optional additional cooling to be provided.

An example of the control system is shown in FIG. 5. As shown the controller 405 generally includes a processor 500, a memory 501, an input/output device 502 and an external interface 503 interconnected via a bus 504 as shown. In use the external interface 503 is used to connect the control system to the pump 404 and the temperature sensor 406.

The memory 501 is utilised to store information used in controlling the pump speed.

In one example, the memory 501 can be used to store an LUT (Look Up Table) that indicates for given temperature values, the pump speed which should be utilised. This allows the processor 500 to determine signals from the temperature sensor 406 and use these to access the LUT, and generate appropriate control signals for controlling the pump speed. The input/output device 502 can be utilised to modify the settings as required.

Thus, the controller may be in the form of a suitably programmed processing system, such as a computer, laptop, palm top, PDA, specialised hardware, programmable logic controller, or the like.

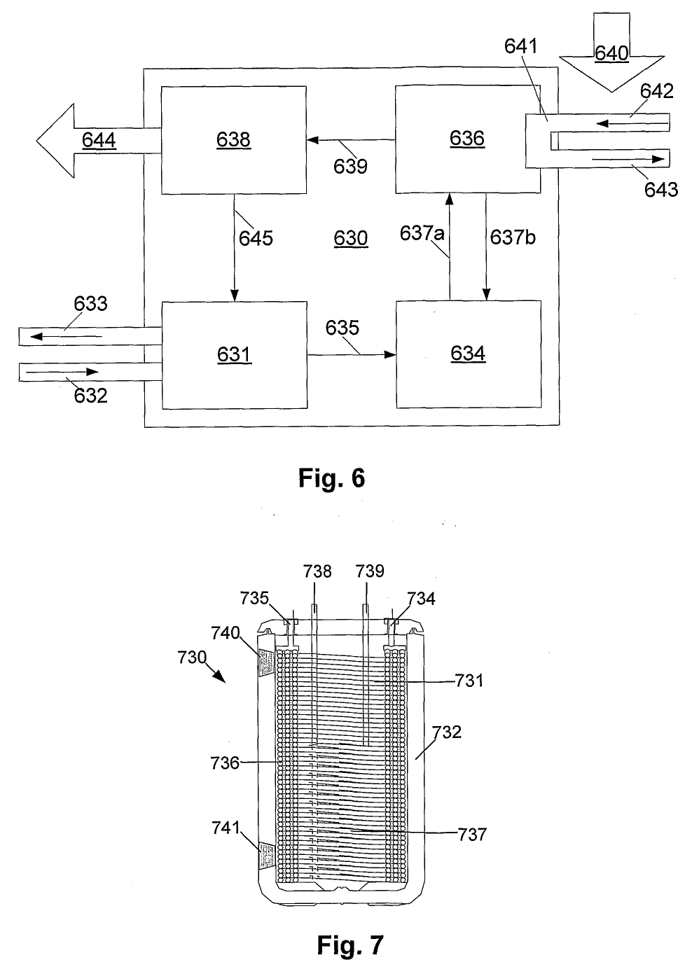

An example of an absorption chiller will now be described with reference to FIG. 6.

In particular, the absorption chiller 630 includes an evaporator 631 having an inlet 632 and an outlet 633. The evaporator 631 is coupled to an absorber 634, via a pipe 635, which is in turn connected to a generator 636 via pipes 637A, 637B as shown. A pipe 641, having an inlet 642, and an outlet 643 receives heat from an appropriate heat source, as shown at 640, and transfers this to the generator 636. The generator 636 is connected to a condenser 638 via a pipe 639. The condenser 638 typically generates waste heat as shown at 644 and is also coupled to the evaporator 631 via a pipe 645.

The system utilises a solution formed form a combination of a refrigerant and an absorber in order to provide heat transfer mechanisms, as will now be described. Typically the solution is either a water/lithium bromide or an ammonia/water combination as will be appreciated by a person skilled in the art.

In use, the evaporator 631 operates to receive liquid refrigerant from the condenser 638, via the pipe 645. The refrigerant is provided into a low-pressure environment within the evaporator 631, and evaporates, thereby extracting heat from fluid supplied to the inlet 632, via an appropriate heat exchanger. The chilled fluid is then output via the outlet 633, whilst the evaporated refrigerant is transferred via the pipe 635 to the absorber 634, where it is absorbed by a refrigerant-depleted solution.

The solution is transferred via the pipe 637A to the generator 636, which operates to heat the solution using fluid in the pipe 641, thereby causing the refrigerant to be evaporated. The remaining refrigerant-depleted solution returns to the absorber 634 via the pipe 637B, whilst the vaporised refrigerant is transferred via the pipe 639 to the condenser 638. The vaporised refrigerant is allowed to condense with waste heat being output at 644 before being transferred via the pipe 645 to the evaporator 631, thereby allowing the cycle to be repeated.

An example of a hot water storage system will now be described with respect to FIG. 7. In this example, a Rotex SC500 730 (also referred to as a “Rotex Sanicube”) having a cavity 731, provided in an insulated housing 732. The cavity contains a heat exchanger 736, having an inlet 734 and an outlet 735, and a heat exchanger 737, having an inlet 738 and an outlet 739, as well as side connectors 740, 741. In use, heat can be supplied to the cavity either by heating water in the cavity 731 using a heating element or the like, or alternatively by recirculating hot water through one of the heat exchangers 736, 737, or through the cavity directly using the side connectors 740, 741. This allows water in one of the heat exchangers 736, 737 to be heated, thereby providing a source of hot water.

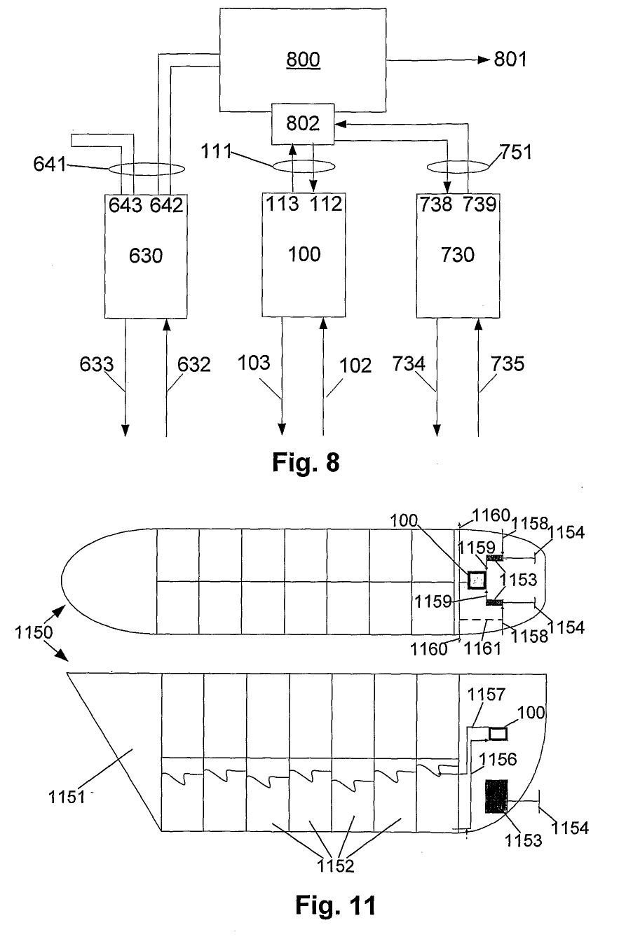

An example of the combination system will now be described with reference to FIG. 8. In particular, as shown at FIG. 10 the system utilises a generator 800 which is coupled to a fluid disinfection system 100, an absorption chiller 630 and a hot water storage system 730 as shown.

In particular, the generator 800 will operate to generate electricity, which is provided via an output 801 as shown. The generator 800 is typically a combustion engine based system, or the like, which therefore generates a significant amount of waste heat. The waste heat is extracted via use of a heat exchanger 802, thereby allowing heat to be provided to the fluid disinfection system 100, the absorption chiller 630 and the water storage system 730.

The exact manner in which this is achieved will depend on the respective implementation. Thus, in the example shown in FIG. 8, the heat exchanger 802 is used to heat fluid, such as water, in each of the pipes 111, 751. Consequently, the FDS 100 and the water storage system 730 are directly heated by waste heat from the generator 800. Additionally, the pipe 641 is connected to the generator exhaust so that the exhaust gases from the generator 800 provide the heating required to operate the chiller 630. It will be appreciated that a wide variety of configurations may be used and that this is for the purpose of example only. In any event, this allows waste heat from the generator to disinfect water, generate chilled fluid and provide hot water, by having each of the FDS 100, absorption chiller 630 and hot water system 730 operate as described above.

The system therefore allows electricity to be generated in the normal way, and produce hot water, disinfected water and chilled water substantially from waste heat created during the electricity generation. This therefore allows hot and disinfected water, as well as chilled fluid to be provided at substantially no additional operating cost in addition to those incurred producing the electricity.

The chilled fluid can be used to provide air conditioning. This can be achieved for example by circulating the chilled fluid through an appropriate heat exchanger configuration, and allowing air to be blown over the heat exchanger to thereby cool the air. Thus, whilst this would therefore require electricity to drive the fan, and pump the chilled fluid through the heat exchanger, this avoids the need to use an electrically driven compressor to provide air conditioning, thereby further reducing the electrical load required to provide the air conditioning.

As a result, the use of a combination system, such as those described above, vastly reduces the operating 40% plus and environmental costs involved in providing facilities in resorts or other remote environments, or the like. In fact, the system may be used to generate hot water, chilled fluid and disinfected water using any heat source. This could include for example existing boilers within hospitals, or the like.

In the case of the absorption chiller, the chilled water is only used for cooling purposes, and this can therefore be recirculated, and will therefore only require occasional replenishment. It will be appreciated from this that in the event that the recirculated water is still below ambient temperature, then the load on the absorption chiller will be reduced.

In any event, as the chilled fluid is generated virtually at no cost, this allows air conditioning to be provided in circumstances that would otherwise be uneconomic. This includes, for example, allowing buildings to be permanently air conditioned, as well as to provide streams of chilled air in external environments, such as around a swimming pool, on a beach, or the like.

In general, the temperature of air produced in this fashion is not as cold as that produced by compression driven air conditioners, but as the air conditioning can be provided permanently at virtually no cost, this allows rooms to be permanently cooled, which assuming sufficient isolation from the environment is provided, will allow a desired room temperature to be achieved regardless of the ambient temperature.

As far as the hot water supply is concerned, it will be appreciated that any unused hot water can be recirculated for reheating, with additional water being supplied as required.

It will be appreciated that the techniques outlined herein could be applied to any form of fluid disinfection system that utilises heat to provide for disinfection or other disinfection of fluid. This could include for example medical applications such as retorting and autoclaving, as well as disinfection systems for the disinfection of milk and the like. It will be appreciated that these applications provide particular benefits.

In particular, in hospitals it is typical to have boilers to supply sufficient hot water for use in washing and the like. In this case, waste heat from the boilers can be used to provide sterilisation of medical equipment, thereby removing the requirement for providing separate sterilisation equipment that uses electric heating of water.

In any event, the provision of a mixture of hot and cold water, as well as disinfected potable water using combination system has specific usefulness in providing emergency relief, for example following natural disasters or the like. However, in order to be of maximum relief, it is necessary for the system to be provided in a manner that is sufficiently portable to allow the system to be transported to and set up in a short time period.

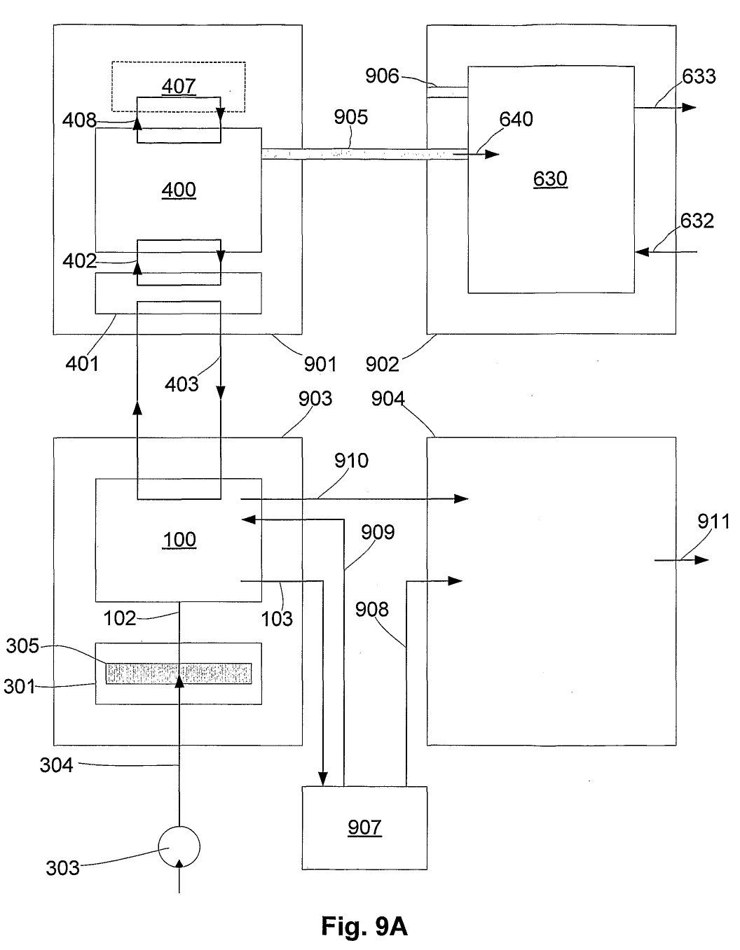

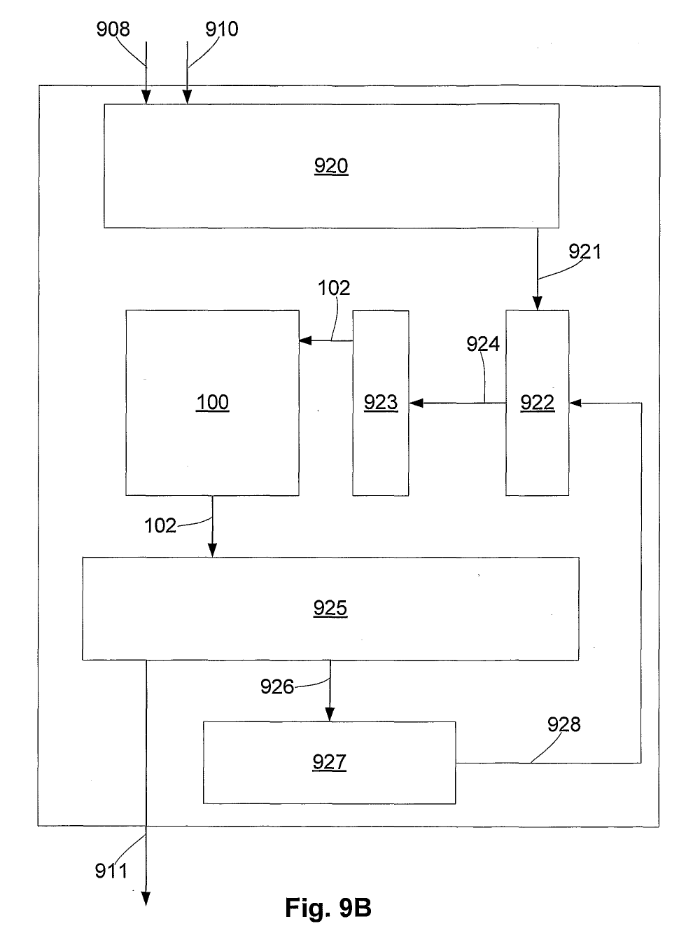

An example of a system specifically configured for providing such emergency relief will now be described with reference to FIGS. 9A and 9B.

As shown in FIG. 9A the apparatus is generally formed from four separate modular units 901, 902, 903, 904. In use the unit 901 contains a generator 400 which is coupled to a heat exchanger 401 via a heat exchanger circuit 402. An optional radiator 407 may be provided coupled to the generator via a radiator circuit 408. It will therefore be appreciated that this is similar to the arrangement proposed in FIG. 4 and in any event provides a self-contained generator unit for generating an electricity supply.

The container 902 includes an absorption chiller 630, which is similar in form to the absorption chiller 630 shown in FIG. 6. This will not therefore be described in any further detail. However, in this instance the absorption chiller 630 is coupled to an exhaust outlet 905 which transfers exhaust gases from the generator 400 to the pipe 641 to act as a heat source 640 as shown. The gases can then be emitted via an outlet 906 as shown. It will therefore appreciated by a person skilled in the art that this absorption chiller can be utilised to chill fluid provided at the inlet 632 with the chilled fluid being provided at the outlet 633.

The container 903 contains a FDS 100, which is typically coupled to a suitable filtration system 310 as shown. In this instance, disinfected fluid is provided via the outlet 103 to a tank 907. The tank 907 is typically a bladder tank that may be shipped within the container 903 and then set up externally to the container 903 in use.

The bladder tank 907 is connected to the container 904 via the connecting pipe 908, as well as to the FDS 100, via the connecting pipe 909. In this instance, heat is supplied to the cavity 231 of the disinfection tank 230 by recirculating water through the cavity via the side connectors 240, 241 (shown in FIG. 2B). This allows the connecting pipe 909 to be coupled to the inlet 238, allowing water from the bladder tank 907 to be heated within the heat exchanger 237, with the resulting hot water being supplied via the pipe 910 to the module 904, as shown.

This module 903 can therefore be used to provide supplies of hot and cold disinfected fluid via the connecting pipes 908, 910.

The container 904 is used to provide washing and toilet facilities and the contents are shown in more detail in FIG. 9B.

As shown, the hot and cold fluid connecting pipes 908, 910 are provided to a shower unit 920, which would typically provide showering facilities for a number of users. Waste water from the shower unit 920 is provided via a pipeline 921, to a sewage treatment plant 922, and onto a filtration system 301 allowing water to be filtered and provided to a further FDS 100 as shown. Thus, the STP 922, and the filtration system 301 would be similar in arrangement to the configuration shown in FIG. 3.

The outlet of the FDS 100 supplies disinfected water to a recycled water storage tank 925 which is in turn connected via a suitable connection pipe 926 to a toilet system 927. Waste water from the toilet system is then returned to the sewage treatment plant 922 as shown.

In use this allows the hot and cold water to be used for washing purposes with this water being then being recycled for further use in the toilet facilities. The recycled water is then treated for use as non-potable water, with excess recycled water being provided via the outlet 911.

In use, the system therefore uses the container 901 to generate electricity, the container 902 to generate chilled fluid, the container 903 to generate potable water for drinking and showering, and the container 904 is used in recycling grey water for use in toilet facilities.

In general the containers 901, 902, 903, 904 are formed from shipping containers or the like. This allows the containers 901, 902, 903, 904 to be provided to an area requiring emergency relief. In particular, the shipping containers are self contained and can therefore easily be transported to emergency locations such as refugee camps or disaster areas. Once provided at the area the shipping containers are interconnected via the appropriate pipes 908, 909, 910, 905 and configured as shown. The system can then be activated to provide electricity, cooling, drinking water, and toilet and shower facilities. It will be appreciated that this can therefore go a significant way to reducing load requirements on emergency relief operations.

An alternative example is shown in FIG. 10. In this example, the system is adapted to be provided on a single skid mounted pallet. In this example, reference numerals from earlier Figures are used to indicate similar integers.

In this example, the pallet container 1000 is provided with an inlet 1001, for collecting water to be disinfected and outlets 1002, 1003 for providing potable and hot water respectively.

In this example, the generator 400 is coupled via the heat exchanger 401 to the side connectors 240, 241, of the FDS disinfection tank 230. This allows water within the cavity 231 to be heated using waste heat from the generator as previously described. A pump 1004 is coupled to the inlet 1001 to allow water to be treated to be pumped through the filter system 301 and into the FDS inlet 112. The water is disinfected and supplied to a potable water storage tank 1005. Drinking water can then be supplied via the outlet 1002, or alternatively, water can be pumped into the inlet 238 of the FDS 100, using the pump 1006, allowing the water to be heated, before being supplied to the outlet 1005.

Accordingly, this configuration is capable of supplying hot and potable water, as well as electricity. Furthermore, by providing this on a single skid mounted pallet, this can be airlifted into locations requiring immediate assistance, thereby providing emergency relief.

A further example of a use of the fluid disinfection system is shown in FIG. 11. In particular, this involves operating to disinfect ballast water within ships.

In this example, the ship 1150 includes a hull 1151 having a number of ballast tanks 1152 interconnected via flow-paths or pipes extending between bulkheads 1152A. This allows flow of water between the respective ballast tanks 1152 to provide for equalisation of ballast water in the tanks. The boat 1150 includes an engine 1153 for driving propellers 1154.

A fluid disinfection system 100 similar to the fluid disinfection systems described above with respect to FIGS. 1 to 4. The fluid disinfection system 100 is coupled to the ballast water tanks 1152 via an inlet pipe 1156 and an outlet pipe 1157. A pump (not shown) is also provided at allow water from the ballast tanks 1152 to be pumped through the fluid disinfection system 100.

The engine 1153 includes a cooling water inlet 1158 which supplies water to a heat exchanger (not shown) provided in thermal contact with the engine. The heat exchanger is coupled via a connecting line 1159 to the fluid disinfection system 100, to act as a heat source as shown by the arrow 110 for example in FIG. 1. This may be achieved for example by connecting the connection line 1159 to the input 238 of the Rotex heat exchanger 230 shown in FIG. 2B. The outlet 239 is then coupled to an engine water cooling outlet 1160 to allow the water to be emitted from the ship

The inlet pipe 1156 is coupled to the bottom of the fluid disinfection tanks 1152 whilst the outlet pipe 1157 to the top of the ballast water tanks 1152. Thus, water is removed from the bottom of the ballast water tanks 1152 and returned to the top of the ballast water tanks. The returned disinfected water is generally at a higher temperature than the water in the ballast tanks and will tend to remain near the surface of the ballast water tanks causing stratification of the ballast water due to convention processes. This ensures that the water circulates through the ballast tanks before being disinfected again, thereby ensuring that the water if all disinfected adequately.

In this instance, as the level of heat generated by the engine 1152 is typically high, this ensures that disinfection can be achieved using no, or only minimal, additional heating. As a result this provides an efficient mechanism for disinfecting and ballast water thereby allowing it to be returned to the sea. Furthermore, as the system includes few moving parts little maintenance is required making the system suitable for long term use.

In the example shown in FIG. 11 the engines 1153 are cooled by water received by the cooling water inlet 1158 from the ocean with the fluid being returned to the ocean via the cooling water outlet 1160. However, as an alternative, the engine cooling system may be in the form of a closed system in which water is recirculated around the loop as shown by the dotted line 1161 which interconnects the cooling water inlet 1158 and the cooling water outlet 1160.

Accordingly, the above described FDS systems and variations thereof can be used in disinfecting ballast water in ships or other vessels.

It will be appreciated by persons skilled in the art that disinfection of fluid is commonly referred to as pasteurisation and that accordingly, the above described techniques can equally apply to disinfection and pasteurisation, which is a particular form of pasteurisation.

Persons skilled in the art will appreciate that numerous variations and modifications will become apparent. All such variations and modifications which become apparent to persons skilled in the art, should be considered to fall within the spirit and scope that the invention broadly appearing before described.

1) Apparatus for disinfecting fluid, the apparatus including:
a) a disinfection tank including a heat exchanger extending from an inlet to an outlet for heating preheated fluid to a second temperature to thereby disinfect the fluid;
b) a preheat heat exchanger for heating the fluid to a first temperature using heat recovered from disinfected fluid provided at the outlet; and,
c) a control system including one, or more sensors for monitoring operation of the apparatus, the control system being for:
i) determining if signals from the sensors fall outside predetermined operating ranges; and,
ii) at least one of:
(1) generating an indication of a fault; and,
(2) stopping operation of the apparatus.

2) Apparatus according to claim 1, wherein the control system is for monitoring at least one of:
a) an operating temperature;
b) water levels;
c) pump operation;
d) heat element operation; and,
e) power supply operation.

3) Apparatus according to claim 1, wherein the heat exchanger has a predetermined length.

4) Apparatus according to claim 1, wherein the heat exchanger is formed from a convoluted pipe.

5) Apparatus according to claim 1, wherein the heat exchanger is formed from a coiled pipe.

6) Apparatus according to claim 4, wherein the coiled pipe is adapted to reduce the effects of channelling within the pipe.

7) Apparatus according to claim 1, wherein the heat source includes a primary circuit and at least one of:
a) a heating element; and,
b) a second heat exchanger coupled to a source of hot fluid.

8) Apparatus according to claim 6, wherein the hot fluid is heated by at least one:
a) waste heat from equipment; and,
b) solar heating.

9) Apparatus according to claim 1, wherein the disinfection tank is a reverse acting califorier.

10) Apparatus according to claim 1, wherein the disinfection tank is a Rotex™ SC500.

11) Apparatus according to claim 1, wherein the heat exchanger is a PE-X heat exchanger.

12) Apparatus according to claim 1, wherein the preheat heat exchanger is a second reverse acting califorier.

13) Apparatus according to claim 1, wherein the preheat heat exchanger is a second Rotex™ SC500.

14) Apparatus according to claim 13, wherein the second inlet and second outlet are coupled to a primary circuit of the second Rotex™ SC500.

15) Apparatus according to claim 14, wherein the preheat heat exchanger is a PE-X heat exchanger.

16) Apparatus according to claim 1, wherein the disinfection tank includes an insulated housing.

17) Apparatus according to claim 1, wherein the heat source includes pipe coupled to a boiler.

18) Apparatus according to claim 17, wherein the fluid at the second temperature is pressurised.

19) Apparatus according to claim 18, wherein the apparatus includes one or more pressure release valves.

20) Apparatus according to claim 1, wherein the fluid is provided at a predetermined rate, and wherein the heat exchanger is adapted to heat the fluid to the second temperature for a predetermined length of time.

21) Apparatus according to claim 20, wherein the apparatus further includes a control system for controlling the predetermined rate.

22) Apparatus according to claim 21, the control system including:
a) a flow control valve; and,
b) a controller for controlling the flow control valve.

23) Apparatus according to claim 22, wherein the apparatus further includes a temperature sensor which generates signals indicative of the second temperature, and wherein the controller controls the predetermined flow rate in accordance with the signals.

24) Apparatus according to claim 22, wherein the controller is a suitably programmed processing system.

25) Apparatus for disinfecting fluid, the apparatus including:
a) a disinfection tank including a heat exchanger extending from an inlet to an outlet for heating preheated fluid to a second temperature using waste heat from a generator, to thereby disinfect the fluid;
b) a preheat heat exchanger for heating the fluid to a first temperature using heat recovered from disinfected fluid provided at the outlet;
c) a pump for pumping fluid through the disinfection tank and the preheat heat exchanger; and,
d) a control system including a temperature sensor coupled to the generator, the control system being adapted to control an operating speed of the pump using signals from the temperature sensor.

26) Apparatus according to claim 25, wherein the transfer of waste heat from the generator is used to cool the generator, and wherein the control system is for:
a) increasing the pump speed in response to an increase in the temperature of the generator; and,
b) decreasing the pump speed in response to a decrease in the temperature of the generator.

27) Apparatus for disinfecting fluid, the apparatus including:
a) a disinfection tank including a heat exchanger extending from an inlet to an outlet for heating preheated fluid to a second temperature to thereby disinfect the fluid;
b) a preheat heat exchanger for heating the fluid to a first temperature using heat recovered from disinfected fluid provided at the outlet; and,
c) a treatment system for pre-treating fluid supplied to the preheat heat exchanger.

28) Apparatus according to claim 27, wherein the treatment system includes at least one of:
a) a filter system for filtering the fluid to remove particulate material;
b) a reverse osmosis system for removing salt from the fluid;
c) a vacuum distillation system for removing salt from the fluid; and,
d) a sewage treatment plant for pre-treating sewage.

29) A supply system including:
a) a generator for generating electricity;
b) an absorption chiller for using exhaust gases from the generator to provide chilled fluid;
c) a fluid disinfection system including a disinfection tank having a heat exchanger extending from an inlet to an outlet for using waste heat from the generator to disinfect fluid; and,
d) a hot water system for using waste heat from the generator to provide heated fluid.

30) Apparatus according to claim 29, wherein the hot water system is formed from a second heat exchanger provided in the fluid disinfection system.

31) Apparatus according to claim 29, wherein the apparatus further includes a storage tank for storing disinfected water for use as potable water.

32) Apparatus according to claim 31, wherein the hot water system is coupled to the storage tank to heat disinfected fluid.

33) Apparatus according to claim 31, wherein the apparatus further includes:
a) one or more washing units coupled to the storage tank and the hot water supply for providing washing facilities; and
b) one or more toilets.

34) Apparatus according to claim 33, wherein the apparatus further includes:
a) a sewage treatment system for treating waste water from at least one of the toilets and the washing units to produce treated waste water; and,
b) a second fluid disinfection system coupled to the sewage treatment system for disinfecting the treated waste water, the disinfected treated waste water being used by the one or more toilets.

35) Apparatus according to claim 34, wherein the apparatus further includes a filtration system for filtering the treated waste water prior to disinfection.

36) Apparatus according to claim 39, wherein the apparatus is provided as a modular system including a number of containers.

37) Apparatus according to claim 36, wherein the containers are shipping containers.

38) Apparatus according to claim 36, wherein:
a) a first container contains the generator;
b) a second container contains the absorption chiller; and,
c) a third container contains the fluid disinfection system and the hot water system.

39) Apparatus according to claim 38, wherein the apparatus includes a fourth container containing one or more washing units and one or more toilets.

40) Apparatus for disinfecting fluid, the apparatus including:
a) a preheat heat exchanger for heating the fluid to a first temperature, the preheat heat exchanger including:
i) a first inlet for receiving the fluid;
ii) a first outlet for supplying preheated fluid at the first temperature;
iii) a second inlet for receiving disinfected fluid substantially at a second temperature; and,
iv) a second outlet for supplying the disinfected fluid; and,
b) a disinfection tank for heating the fluid to a second temperature, the disinfection tank including:
i) a heat source;
ii) an inlet for receiving the preheated fluid;
iii) a heat exchanger coupled to the inlet for heating the preheated fluid to a second temperature to thereby disinfect the fluid; and,
iv) an outlet coupled to the heat exchanger for providing the disinfected fluid to the second inlet of the preheat heat exchanger.

41) Apparatus according to claim 40, wherein the heat exchanger is formed from a coiled or convoluted pipe adapted to reduce the effects of channelling within the pipe.

42) A method of operating apparatus for disinfecting fluid, the apparatus including:
a) a preheat heat exchanger for heating the fluid to a first temperature, the preheat heat exchanger including:
i) a first inlet for receiving the fluid;
ii) a first outlet for supplying preheated fluid at the first temperature;
iii) a second inlet for receiving disinfected fluid substantially at a second temperature; and,
iv) a second outlet for supplying the disinfected fluid; and,
b) a disinfection tank for heating the fluid to a second temperature, the disinfection tank including:
i) a heat source;
ii) an inlet for receiving the preheated fluid;
iii) a heat exchanger coupled to the inlet for heating the preheated fluid to a second temperature to thereby disinfect the fluid; and,
iv) an outlet coupled to the heat exchanger for providing the disinfected fluid to the second inlet of the preheat heat exchanger; and,
v) wherein the method includes supplying the fluid to the first inlet at a predetermined rate.

43) A supply system including:
a) an absorption chiller for using an external heat source to provide chilled fluid;
b) a fluid disinfection system including a disinfection tank having a heat exchanger extending from an inlet to an outlet for using an external heat source to provide disinfected fluid;
c) a hot water system for using an external heat source to provide heated fluid; and,
d) a waste heat recovery system to recover waste heat, the waste heat recovery system acting as an external heat source for at least one of the absorption chiller, the fluid disinfection system and the hot water storage system.

44) Apparatus according to claim 43, wherein the waste heat recovery system includes a heat exchanger coupled to at least one of:
a) a generator; and,
b) a boiler.

45) Apparatus according to claim 43, wherein the waste heat recovery system provides heat to a selected one of the absorption chiller, the fluid disinfection system and the hot water system, the system further including a second waste heat recovery system for:
a) recovering waste heat from the selected one of the absorption chiller, the fluid disinfection system and the hot water system; and
b) providing the waste heat to one of the absorption chiller, the fluid disinfection system and the hot water system.

46) Apparatus according to claim 43, wherein the fluid disinfection system includes:
a) a preheat heat exchanger for heating the fluid to a first temperature, the preheat heat exchanger including:
i) a first inlet for receiving the fluid;
ii) a first outlet for supplying preheated fluid at the first temperature;
iii) a second inlet for receiving disinfected fluid substantially at a second temperature; and,
iv) a second outlet for supplying the disinfected fluid; and,
b) a disinfection tank coupled to an external heat source for heating the fluid to a first temperature, the disinfection tank including:
i) an inlet for receiving the preheated fluid;
ii) a heat exchanger coupled to the inlet for heating the preheated fluid to a second temperature to thereby disinfect the fluid; and,
iii) an outlet coupled to the heat exchanger for providing the disinfected fluid to the second inlet of the preheat heat exchanger.

47) A supply system including:
a) a fluid disinfection system including a disinfection tank having a heat exchanger extending from an inlet to an outlet for using an external heat source to provide disinfected fluid;
b) a hot water system for using an external heat source to provide heated fluid; and,
c) a waste heat recovery system to recover waste heat, the waste heat recovery system acting as an external heat source for at the fluid disinfection system and the hot water storage system.

48) Apparatus for treating ballast water in a vessel, the apparatus including:
a) a preheat heat exchanger for heating the ballast water to a first temperature, the preheat heat exchanger including:
i) a first inlet for receiving the ballast water from a ballast tank;
ii) a first outlet for supplying preheated ballast water at the first temperature;
iii) a second inlet for receiving disinfected ballast water substantially at a second temperature; and,
iv) a second outlet for supplying the disinfected ballast water to the ballast tank; and,
b) a disinfection tank for heating the ballast water to the second temperature, the disinfection tank including:
i) an inlet for receiving the preheated ballast water;
ii) a heat exchanger coupled to the inlet for heating the preheated ballast water to a second temperature to thereby disinfect the ballast water; and,
iii) an outlet coupled to the heat exchanger for providing the disinfected ballast water to the second inlet of the preheat heat exchanger; and,
c) a heat recovery heat system coupled to engines provided in the vessel, the heat recovery system being adapted to heat the disinfection tank, thereby allowing the ballast water to be disinfected.

49) Apparatus according to claim 48, wherein the first inlet is coupled to the ballast tank at a first level and the second outlet is coupled to the ballast tank at a second level, the second level being higher than the first level to thereby ensure disinfected water is returned to the ballast tank at a higher level.

50) Apparatus for treating ballast water in a vessel, the apparatus including:
a) a heat recovery heat system for recovering heat from at least one of an engine and a boiler; and,
b) a fluid disinfection system for heating the ballast water to a predetermined temperature using the recovered waste heat, to thereby disinfect the ballast water.
